(19) United States
(12) Patent Application Publication
(10) Pub. No.: US 2018/0106659 A1
(43) Pub. Date: Apr. 19, 2018

(54) AUTOMATED VOLUMETRIC MEASUREMENT AND VERIFICATION SYSTEM

(71) Applicant: Centech Corp., Los Angeles, CA (US)

(72) Inventors: Omar Bennabi Kunbargi, Los Angeles, CA (US); Chakib Mouzaoui, San Ramon, CA (US)

(73) Assignee: Centech Corp., Los Angeles, CA (US)

(21) Appl. No.: 15/785,422

(22) Filed: Oct. 16, 2017

Related U.S. Application Data
(60) Provisional application No. 62/408,771, filed on Oct. 15, 2016.

(51) Int. Cl. G01F 25/00; G01F 23/292; G01F 17/00; G01N 21/01

(52) U.S. Cl. CPC G01F 25/0061; G01F 25/0084; G01N 21/01; G01F 17/00; G01F 23/292

(57) ABSTRACT

An automated volumetric measurement and verification system capable of measuring and verifying volumetric graduations on a container and methods of measuring and verifying volumetric graduations on a container using the disclosed volumetric measurement and verification system are disclosed herein. The volumetric measurement and verification system comprises a graduated container capable of containing a liquid, a camera, and one or more z-axis stages for positioning the camera. In embodiments of the disclosed system that are used to verify volumetric graduations, the system may further comprise a liquid dispenser and a balance, and the one or more z-axis stages may further position the liquid dispenser.

### CROSS-REFERENCE TO RELATED APPLICATIONS

This application claims priority to U.S. Provisional Patent Application Ser. No. 62/408,771, filed on Oct. 15, 2016, the disclosure of which is incorporated herein in its entirety by reference.

### BACKGROUND

### Field of the Invention

The present disclosure relates to an automated volumetric measurement and verification system.

### Description of the Related Art

Sample analysis in a laboratory setting often requires precise determination of the volume of a liquid. Volumetric containers offer a straightforward method of determining the volume of a liquid. However, the graduations on volumetric containers are subject to sources of error. As any container may be subject to manufacturing inconsistencies, it is often necessary in a laboratory sample analysis to determine the error between the volume indicated by a stated graduation and the actual volume contained in the container when a liquid with a meniscus at the level of the graduation is measured.

In addition, human error based on inconsistencies in how the volume of a liquid in a graduated container is determined may introduce a lack of precision in measuring the volume of a liquid regardless of the accuracy of graduations on a volumetric container.

Thus there remains a need for an automated system of volumetric verification and measurement for liquids in a graduated container.

### SUMMARY

An automated volumetric measurement and verification system capable of measuring and verifying volumetric graduations on a container and methods of measuring and verifying volumetric graduations on a container using the disclosed volumetric measurement and verification system are disclosed herein. The volumetric measurement and verification system comprises a graduated container capable of containing a liquid, a camera, and one or more z-axis stages for positioning the camera. In embodiments of the disclosed system that are used to verify volumetric graduations, the system may further comprise a liquid dispenser and a balance, and the one or more z-axis stages may further position the liquid dispenser.

### BRIEF DESCRIPTION OF THE DRAWINGS

FIG. 1 shows a schematic drawing of an embodiment of the volumetric measurement and verification system that may be used to verify volumetric graduations on a graduated container.

FIG. 2 shows a block diagram of an embodiment of a method of verifying volumetric graduations on a graduated container.

FIG. 3 shows a top view of an embodiment of the disclosed automated volumetric measurement and verification system that may be used to verify volumetric graduations on a graduated container.

FIG. 4 shows an isometric front view of an embodiment of the disclosed automated volumetric measurement and verification system that may be used to verify volumetric graduations on a graduated container.

FIG. 5 shows an isometric back view of an embodiment of the disclosed automated volumetric measurement and verification system that may be used to verify volumetric graduations on a graduated container.

FIG. 6 shows a block diagram of an embodiment of a method of measuring volume of a liquid in a graduated container using the disclosed automated volumetric measurement system.

### DETAILED DESCRIPTION OF ILLUSTRATED EMBODIMENTS

An automated volumetric measurement and verification system capable of measuring and verifying volumetric graduations on a container and methods of measuring and verifying volumetric graduations on a container using the disclosed volumetric measurement and verification system are disclosed herein. The volumetric measurement and verification system comprises a graduated container capable of containing a liquid, a camera, and one or more z-axis stages for positioning the camera. In embodiments of the disclosed system that are used to verify volumetric graduations, the system may further comprise a liquid dispenser and a balance, and the one or more z-axis stages may further position the liquid dispenser.

In some embodiments, the disclosed system may be an automated volumetric verification system that may be used to verify volumetric graduations on a graduated container. The automated volumetric verification system may comprise a graduated container capable of containing a liquid, a balance, a liquid dispenser, a camera, and one or more z-axis stages for positioning the camera and the liquid dispenser.

In some embodiments, the graduated container may be held in place using a jig, wherein the jig mechanically maintains the correct positional relationship between the container and other components of the system. The jig securing the container may preferably sit on a balance, wherein the balance may be used to determine the combined mass of the jig, the graduated container, and the liquid contained within the graduated container and to separately determine the combined mass of the jig and the graduated container only. The balance may alternatively be zeroed after the jig and graduated container are placed on the balance but before any liquid is added to the graduated container, and then be used to determine the mass of the liquid contained within the graduated container directly.

In some embodiments, the automated volumetric verification system may further comprise an electromagnetic radiation source. In some preferred embodiments, the electromagnetic radiation source delivers infrared radiation. The electromagnetic radiation source may preferably be an infrared backlight.

In some embodiments, the automated volumetric verification system may further comprise a microcontroller and a computing device.

In some embodiments, the balance may preferably be a digital balance.

In some embodiments, the liquid dispenser dispenses water. In some embodiments, the liquid dispenser may comprise a solenoid valve which allows a fixed amount of liquid to be dispensed into the graduated container.

In some embodiments, the liquid dispenser may be connected to a liquid feed line, wherein liquid dispensed into the graduated container by the liquid dispenser is contained within the liquid feed line. The liquid feed line may preferably be pressurized. The liquid dispenser may preferably be a water dispenser that dispenses water, and the liquid feed line may preferably be a pressurized water feed line.

In some preferred embodiments, the camera is a machine vision camera. The use of a machine vision camera allows for imaging-based automatic inspection and analysis using the camera component of the system.

In some embodiments, the one or more z-axis stages may comprise a single z-axis stage that simultaneously positions the camera and the liquid dispenser. In other embodiments, the one or more z-axis stages may comprise two z-axis stages, wherein one z-axis stage positions the camera and a separate z-axis stage positions the liquid dispenser.

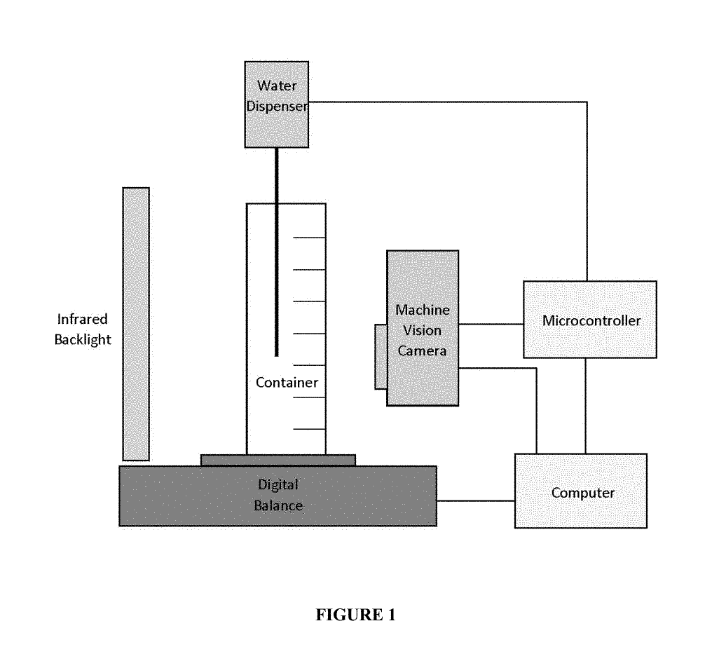

FIG. 1 shows a schematic diagram of an embodiment of the automated volumetric verification system.

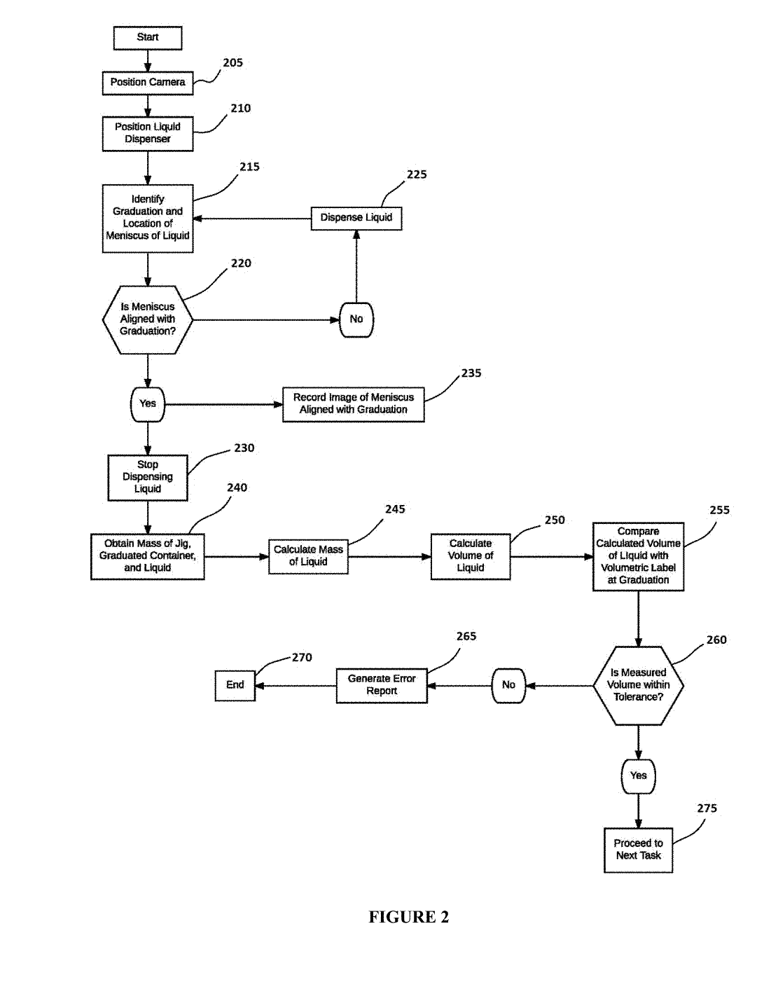

FIG. 2 shows an embodiment of a method for verifying volumetric graduations using the automated volumetric verification system disclosed herein. At step 205, an instruction may be sent to position the camera using the z-axis stage that is connected to the camera. For example, an instruction may be sent to position the camera so that the camera may be used to observe and generate images of the meniscus of a liquid contained in the graduated container. At step 210, an instruction may be sent to position the liquid dispenser using the z-axis stage that is connected to the liquid dispenser. For example, an instruction may be sent to position the liquid dispenser directly above or inside the graduated container. At step 215, images received from the camera may be used to identify a specific graduation on the graduated container, wherein the graduation is identified by a volumetric label, and locate the meniscus of a liquid contained in the graduated container.

At step 220, a determination may be made whether the meniscus is aligned with the graduation. At step 225, if the meniscus of the liquid in the graduated container is below the graduation under analysis, an instruction may be sent to dispense liquid via the liquid dispenser. At step 230, if the meniscus of the liquid is aligned with the graduation under analysis, an instruction may be sent to stop adding liquid via the liquid dispenser. At step 235, an image of the meniscus of the liquid may be recorded using the camera.

At step 240, a measurement of the combined mass of a jig used to secure the graduated container, the graduated container, and the liquid contained within the graduated container may be obtained using the balance. At step 245, the mass of the liquid contained within the graduated container may be calculated using the mass obtained at step 240 and the predetermined combined mass of the jig and the graduated container. At step 250, the volume of the liquid may be calculated using the mass obtained at step 245 and the density of the liquid. At step 255, the calculated volume of the liquid may be compared to the volume indicated by the volumetric label of the graduation under analysis. At step 260, a determination may be made whether the graduation under analysis is within a defined tolerance. At step 265, if the determination is that the graduation of a test tube is not within a defined tolerance, an error report may be generated. At step 270, if an error report is generated, an instruction may be sent to cease operation of the system until instructed otherwise. At step 275, if the determination is that the graduation under analysis is within a defined tolerance, an instruction may be sent to proceed to the next task.

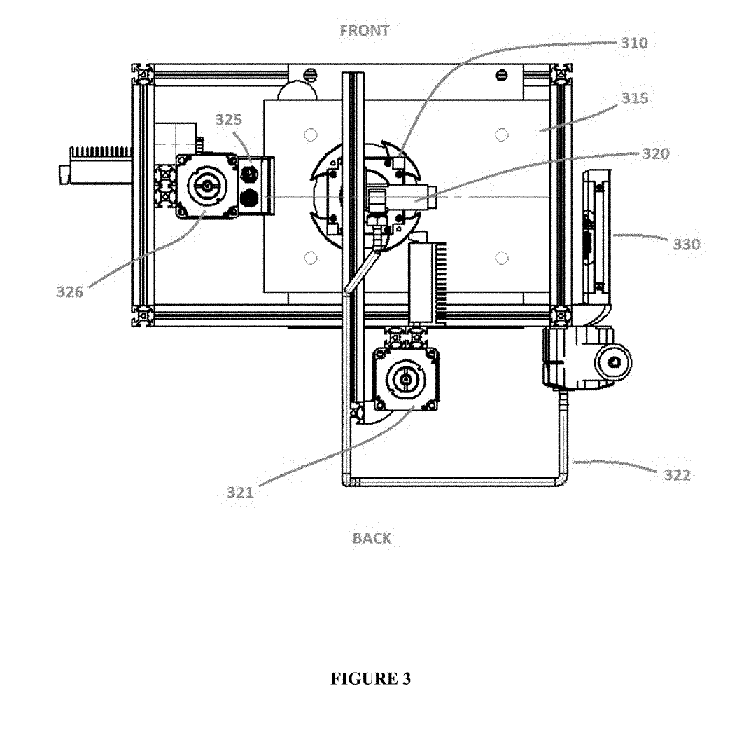

FIG. 3 shows a top view of an embodiment of the disclosed automated volumetric verification system comprising a graduated container secured by a jig 310, a balance 315, a liquid dispenser comprising a solenoid valve 320, a z-axis stage for positioning the liquid dispenser 321, a liquid feed line 322, a machine vision camera 325, a z-axis stage for positioning the machine vision camera 326, and an infrared backlight 330.

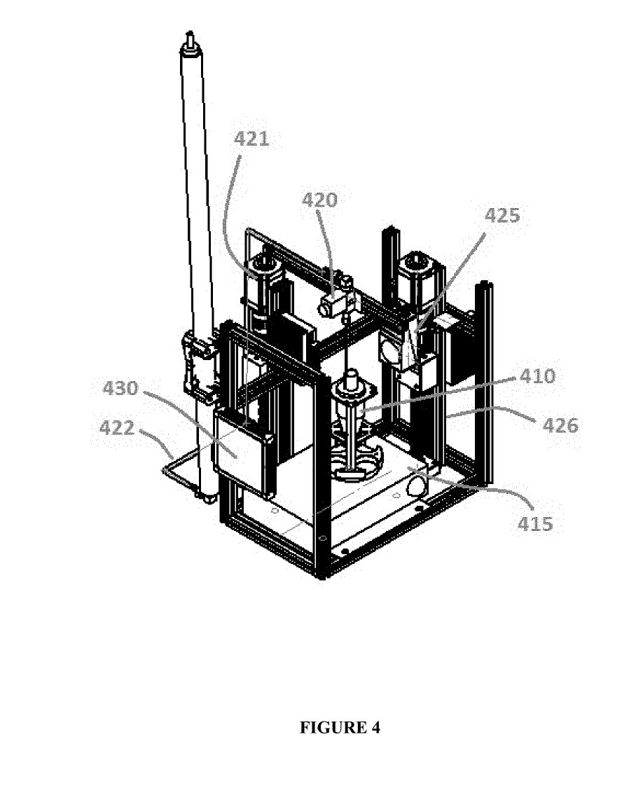

FIG. 4 shows an isometric front view of an embodiment of the disclosed automated volumetric verification system comprising a graduated container secured by a jig 410, a balance 415, a liquid dispenser comprising a solenoid valve 420, a z-axis stage for positioning the liquid dispenser 421, a liquid feed line 422, a machine vision camera 425, a z-axis stage for positioning the machine vision camera 426, and an infrared backlight 430.

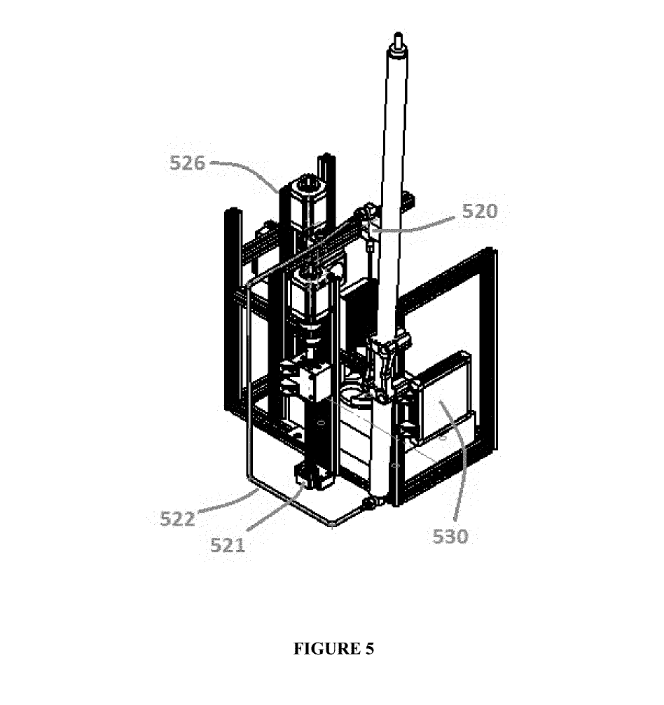

FIG. 5 shows an isometric back view of an embodiment of the disclosed automated volumetric verification system comprising a graduated container secured by a jig, a balance, a liquid dispenser comprising a solenoid valve 520, a z-axis stage for positioning the liquid dispenser 521, a liquid feed line 522, a machine vision camera, a z-axis stage for positioning the machine vision camera 526, and an infrared backlight 530.

The disclosed automated volumetric verification system and method of verifying volumetric graduations using the disclosed automated volumetric verification system may be used to calibrate volumetric graduations on graduated containers so that volumes determined using said volumetric graduations may be accurate.

In some embodiments, the disclosed system may be an automated volumetric measurement system that may be used to measure the volume of a liquid in a graduated container. The automated volumetric measurement system may comprise a graduated container capable of containing a liquid, a camera, and one or more z-axis stages for positioning the camera.

In some embodiments, the graduated container may be held in place using a jig, wherein the jig mechanically maintains the correct positional relationship between the container and other components of the system.

In some embodiments, the automated volumetric measurement system may further comprise an electromagnetic radiation source. In some preferred embodiments, the electromagnetic radiation source delivers infrared radiation. The electromagnetic radiation source may preferably be an infrared backlight.

In some embodiments, the automated volumetric measurement system may further comprise a microcontroller and a computing device.

In some preferred embodiments, the camera is a machine vision camera. The use of a machine vision camera allows for imaging-based automatic inspection and analysis using the camera component of the system.

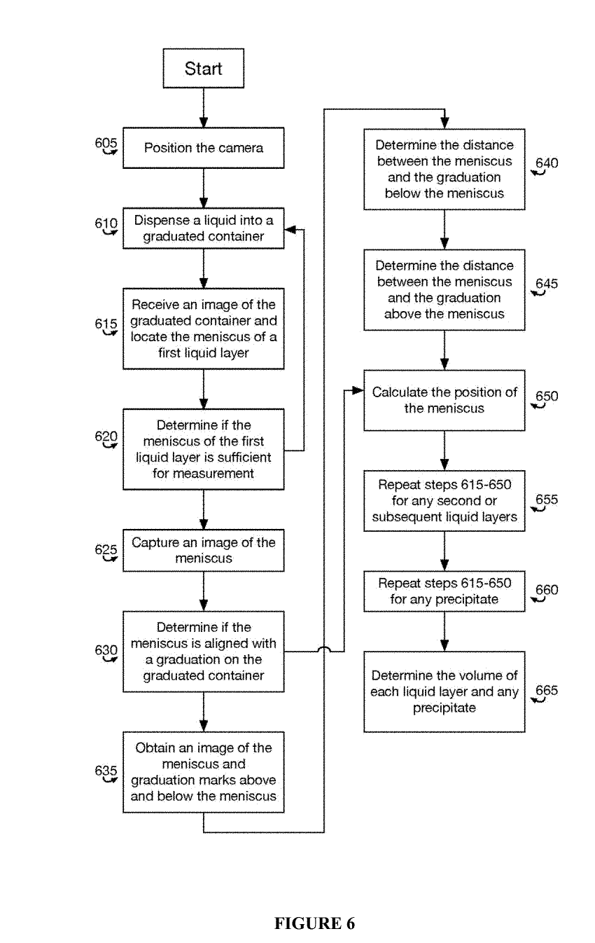

FIG. 6 shows an embodiment of a method for measuring the volume of a liquid or components of a liquid in a graduated container using the automated volumetric measurement system disclosed herein. At step 605, an instruction may be sent to position the camera using the z-axis stage that is connected to the camera. For example, an instruction may be sent to position the camera so that the camera may be used to observe and generate images of the meniscus of a liquid or a component of a liquid contained in the graduated container. At step 610, a liquid 700 may be dispensed into the graduated container. The liquid may be homogeneous, wherein the liquid may form a single liquid layer, or the liquid may be heterogeneous, wherein the liquid may form two or more separate liquid layers. For example, the liquid may be a heterogeneous crude oil sample comprising a hydrocarbon layer residing above an aqueous layer, such as a crude oil sample being tested for its sediment and water content. In some embodiments, the liquid may be prior to or after dispensing the liquid into the graduated container, such as by the use of mechanical systems or components known in the art to separate a heterogeneous mixture into separate liquid layers, such as a centrifuge. Some embodiments may also use more one than dispenser for distributing components to form liquid 700. For example, a first dispenser may dispense a crude oil sample and a second dispenser may dispense an oil coagulant to form liquid 700. At step 615, images received from the camera may be used to locate the meniscus 710 of a first liquid layer contained in the graduated container.

At step 620, in some embodiments, a determination may be made regarding the position of the meniscus of the first liquid layer contained in the graduated container, such as that additional liquid must be added to raise the meniscus of the first liquid layer (e.g., because it is below the lowest graduation on the graduated cylinder). At step 625, an image of the meniscus of the first liquid layer may be recorded using the camera.

In some embodiments, steps 620 and 625 may be omitted (e.g., for analysis of field samples where addition of liquid is not possible, not practical, or not desired for the given application).

At step 630, a determination may be made whether the meniscus 710 is aligned with a graduation on the graduated container. At step 635, if the meniscus 710 is not aligned with a graduation on the graduated container, an instruction may be sent to obtain an image 720 that shows the meniscus 710, the graduation 730 on the graduated container that is immediately below the meniscus, and the graduation 740 on the graduated container that is immediately above the meniscus. At step 640, the distance between the meniscus 710 and the graduation 730 on the graduated container that is immediately below the meniscus may be determined from image 720. At step 645, the distance between the meniscus 710 and the graduation 740 on the graduated container that is immediately above the meniscus may be determined from image 720. At step 650, the distances determined in steps 640 and 645 may be used to calculate the position of the meniscus 710.

At step 655, if the liquid 700 comprises more than one liquid layer, an instruction may be sent to repeat steps 615 through 650 for the second and subsequent liquid layers.

At step 660, if the liquid 700 further comprises a precipitate 750, an instruction may be sent to repeat steps 615 through 650 for the precipitate, wherein the “meniscus” of the precipitate 750 is simply the interface between the precipitate and the first liquid layer.

At step 665, if the position of the menisci has been determined for all liquid layers and any precipitate within liquid 700, the positions of the menisci may be used to determine the volume of each liquid layer and any precipitate within liquid 700.

The disclosed automated volumetric measurement system and method of measuring the volume of a liquid in a graduated container using the disclosed automated volumetric measurement system may facilitate precise and accurate measurement of sample volumes in various applications. Such applications include, for example, the precise and accurate measurement of sediment and water in crude oil samples.

The flowchart and block diagrams in the Figures illustrate the architecture, functionality, and operation of possible implementations of systems, methods, and computer program products according to various embodiments disclosed herein. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures or may be omitted. For example, two blocks shown in succession may, in fact, be executed substantially concurrently, or the blocks may sometimes be executed in the reverse order, depending upon the functionality involved. It should also be noted that each block of the block diagrams or flowchart illustration, and combinations of blocks in the block diagrams and/or flowchart illustration, can be implemented by special purpose hardware-based systems that perform the specified functions or acts, or combinations of special purpose hardware and computer instructions. In addition, any references to steps of a methodology are used herein only to facilitate discussion, and carry no particular temporal or chronological significance unless otherwise indicated.

The previous description of the disclosed embodiments is provided to enable any person skilled in the art to make or use the invention disclosed herein. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. Other modifications will become apparent to the skilled practitioner upon a study of the drawings and descriptions provided herein. All references cited herein are expressly incorporated by reference.

What is claimed is:

1. An automated volumetric verification system comprising a graduated container capable of containing a liquid, a balance, a liquid dispenser, a camera, and one or more z-axis stages for positioning the camera and the liquid dispenser.

2. The system of claim 1 further comprising a jig, wherein the jig mechanically maintains the correct positional relationship between the graduated container and other components of the system.

3. The system of claim 2 wherein the jig sits on the balance.

4. The system of claim 1 further comprising an electromagnetic radiation source.

5. The system of claim 1 further comprising a microcontroller and a computing device.

6. The system of claim 1 wherein the balance is a digital balance.

7. The system of claim 1 wherein the liquid dispenser dispenses water.

8. The system of claim 7 wherein the liquid dispenser comprises a solenoid valve which allows a fixed amount of liquid to be dispensed into the graduated container.

9. The system of claim 8 wherein the liquid dispenser is connected to a liquid feed line, and wherein liquid dispensed into the graduated container by the liquid dispenser is contained within the liquid feed line.

10. The system of claim 9 wherein the liquid feed line is a pressurized water feed line.

11. The system of claim 1 wherein the camera is a machine vision camera.

12. The system of claim 1 wherein the one or more z-axis stages comprise a single z-axis stage that simultaneously positions the camera and the liquid dispenser.

13. The system of claim 1 wherein the one or more z-axis stages comprise two z-axis stages, wherein a first z-axis stage positions the camera and a second z-axis stage positions the liquid dispenser.

14. The system of claim 13 further comprising a jig, an electromagnetic radiation source, a microcontroller, and a computing device, wherein the balance is a digital balance, wherein the camera is a machine vision camera, wherein the liquid dispenser comprises a solenoid valve and is connected to a pressurized water feed line, and wherein the jig mechanically maintains the correct positional relationship between the graduated container and other components of the system and wherein the jig sits on the balance.

15. A computer-operable method of verifying volumetric graduations using an automated volumetric verification system comprising the steps of:
sending positioning instructions to adjust the position of a camera for observing a set of graduation marks on a cylinder;
sending a first set of dispensing instructions to a dispenser for dispensing a liquid into the cylinder;
receiving an image from a camera indicating the position of a meniscus of the liquid relative to the set of graduation marks;
determining if the meniscus is aligned with a graduation mark within the set of graduation marks and if not aligned a target graduation mark located above the meniscus;
sending a second set of dispensing instructions, if the meniscus is not aligned, to the dispenser to dispense additional liquid until the meniscus is aligned with the target graduation mark; and
determining the mass and volume of the liquid in the cylinder.

16. A computer-operable method of measuring the volume of a liquid in a graduated container using an automated volumetric measurement system comprising the steps of:
sending positioning instructions to adjust the position of a camera for observing a set of graduation marks on a cylinder;
sending a first set of dispensing instructions to a dispenser for dispensing a liquid into the cylinder;
receiving an image from a camera indicating the position of one or more menisci of the liquid relative to the set of graduation marks; and
for each meniscus:
identifying an upper graduation mark above or aligned with the meniscus;
identifying a lower graduation mark below or aligned with the meniscus; and
determining the position of the meniscus relative to the upper and lower graduation marks based on the image.
